(19) United States
(12) Patent Application Publication
(10) Pub. No.: US 2021/0024179 A1
(43) Pub. Date: Jan. 28, 2021

(54) SURFBOARD WITH CARRIER FOR COMPONENTS OF A JET DRIVE

(71) Applicant: WBV Weisenburger Bau+Verwaltung GMBH, Rastatt (DE)

(72) Inventor: Nicolai Weisenburger, Baden-Baden (DE)

(21) Appl. No.: 16/956,565

(22) PCT Filed: Dec. 20, 2018
(86) PCT No.: PCT/EP2018/086361

§ 371 Date: Jun. 20, 2020

(30) Foreign Application Priority Data
Dec. 21, 2017 (DE) 10 2017 130 966.7

(51) Int. Cl. B63B 32/10; B63H 11/02; B60L 50/64; B60L 53/22; B63B 32/51

(52) U.S. Cl. CPC B63B 32/10; B63H 11/02; B60L 50/64; B63B 5/24; B63B 32/51; B60L 2200/32; B60L 53/22

(57) ABSTRACT

The invention relates to a surfboard having a hull (22) and a jet drive (2) arranged in the hull (22) and a battery arranged in the hull (22) for the jet drive (2), wherein the jet drive (2) is mounted on a carrier (17) and the carrier (17) can be releasably fastened to the hull (22) by fastening means and can be removed from the hull (22) together with the jet drive (2) after the release of the fastening means.

The invention relates to a surfboard having a hull and a jet drive arranged in the hull.

Surfboards with an electric drive are known for example from DE 20 2011 051 071. The powered surfboards are advantageously not dependent on a heavy swell, but can also be used in bodies of water which are windless and have little surf. By comparison with conventional surfboards without an electric drive the powered surfboards naturally require significantly more maintenance, and it has been shown that individual components can also fail from time to time. It has proved disadvantageous that the entire surfboard must be sent away for repair or the individual components must be laboriously dismantled.

DE 10 2015 103 503 A1 discloses an inflatable surfboard with a recess for a drive component at the stern end. The drive component comprises an electric drive. Disadvantageously, the drive is encapsulated in the drive component and it is therefore accessible only with difficulty. The same also applies to the surfboard of DE 20 2015 009 474 U1.

US 2015/0086337 A1 discloses a surfboard with a likewise encapsulated drive. Furthermore, the batteries are disadvantageously part of the removable drive.

The object of the invention is therefore to provide a surfboard with a drive which can be easily repaired.

This object is achieved by a surfboard referred to in the introduction with the features of claim 1.

Preferred embodiments are the subject matter of the subordinate claims.

The invention makes use of the idea that at least some components, preferably all components in the case of a drive powered by a petrol engine, and all necessary components apart from a battery in the case of a drive powered by an electric motor, in particular the motor itself, in particular a controller, in particular a converter, a rotor as well as in particular a jet tube, are mounted on a carrier. A rotor may be understood as a propeller, an impeller or the like.

In this case a carrier is understood to be a mounting device which can have a planar configuration in part along a base panel. The components are fastened on the carrier at predetermined positions. The fastening devices are advantageously releasable, for example in the form of screws, quick-action closures or the like.

The carrier can be inserted with the components at least substantially, preferably completely in a positively locking manner into a recess provided in the hull of the surfboard. In this case the carrier can be inserted into the recess in such a way that an outer skin of the surfboard is preferably completely smooth over the entire surface. Along the outer skin a positively engaged connection is produced between the carrier and the surfboard.

The connecting line between the carrier and the surfboard is preferably watertight. In this way the components are protected against contact with water.

The individual components, in particular the electric motor, the converter and the controller are advantageously encapsulated in a watertight manner. In this case the individual components are preferably assigned the classifications PI 67, 68 or 69. Due to the separate and individual encapsulation of the components, water can penetrate into the carrier, and advantageously the drive nevertheless remains functional.

For this purpose the electrical connections between the components are preferably also assigned the same sealing classifications.

The invention makes use of the idea that in the event of a defect of the drive the entire carrier with the components arranged thereon is removed. According to the invention, after the removal of the carrier from the hull the jet drive is arranged freely accessibly on the carrier.

On the one hand, as a result the components are significantly more easily accessible and can be repaired, and on the other hand it is possible to remove obviously defective components and to repair or replace them separately. It is also possible to send the entire carrier and its components away for repair.

The carrier preferably has a base panel on which the jet drive is mounted. The carrier advantageously consists only of the base panel and, if required, also a wall at the stern end. The carrier is open towards the top. The components of the drive are mounted on the inner face of the base panel. However, the drive is not covered by a cover which is connected to the carrier and can be removed from the hull. The drive lies freely on the carrier and is inserted so that it is exposed in a recess on the underside of the hull.

The carriers are preferably designed with the same shape for different surfboards, even different surfboard models, so that the carriers can be interchanged between the surfboards.

The carrier preferably has a base panel with an opening for a water inlet and an end face projecting from the edge of the panel at the stern end and having an opening for the water outlet. The end face and the base panel can be connected to one another for example by means of lateral brackets for reinforcement. The carrier can be made from a plastic material, for example it may be a one-piece injection moulded component.

The components are advantageously screwed firmly onto the carrier by means of conventional screws, nylon screws or other screws. However, also clamp closures, press-in closures or other fastening mechanisms can also be provided.

In an advantageous embodiment of the invention an inlet of the jet tube is connected to the water inlet and an outlet of the jet tube is connected to the water outlet. The jet tube is designed with a length such that it fits precisely between the two openings in the base panel and the end face and produces the water-conveying connection between the water inlet and the water outlet. A rotor which ensures the actual propulsion of the surfboard is arranged in the jet tube.

In principle two embodiments of the hull are conceivable for the surfboard according to the invention. The hull can be designed as a permanently firm component. In this case a core is provided which contains form and is covered for example with a laminate. The hull then has a recess in the stern end, into which the carrier can be fitted. The carrier can be fastened by means of fastening means. It can also be inserted or, from the deck, can be fastened to the hull from above by means of fastening means such as screws.

In another embodiment of the surfboard the hull is designed as an inflatable hull component which has lateral arms forming an approximately U-shaped recess into which a drive unit can be inserted. The drive unit includes the carrier according to the invention with the components mounted thereon, as well as the further necessary components, in particular the battery. In both embodiments of the invention, however, the carrier preferably does not include the battery, which is arranged separately, spaced apart from the carrier, in the surfboard. The battery must be replaced more frequently than the carrier, for example if it is desired to save on time-consuming charging processes and simply to replace an empty battery with a charged battery. For this purpose the battery is electrically connected to the rest of the drive unit by means of releasable plug connections, such as for example a high-current plug, and is fastened mechanically in the drive unit by a releasable fastening mechanism.

The carrier is also characterised according to the invention by the base panel, on which are arranged the components of the jet drive which are freely accessible from the side opposite the base panel. The carrier can advantageously be pushed in or inserted into a recess of the hull component and ideally is dimensioned so that it forms a substantially positively engaged connection or a clamp connection with the hull component.

The invention is described with reference to an embodiment in four figures. In the drawings:

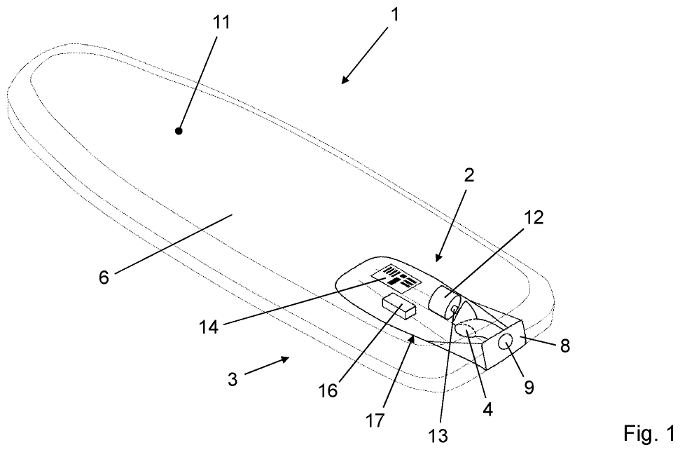

FIG. 1 shows a view through a surfboard according to invention with a carrier,

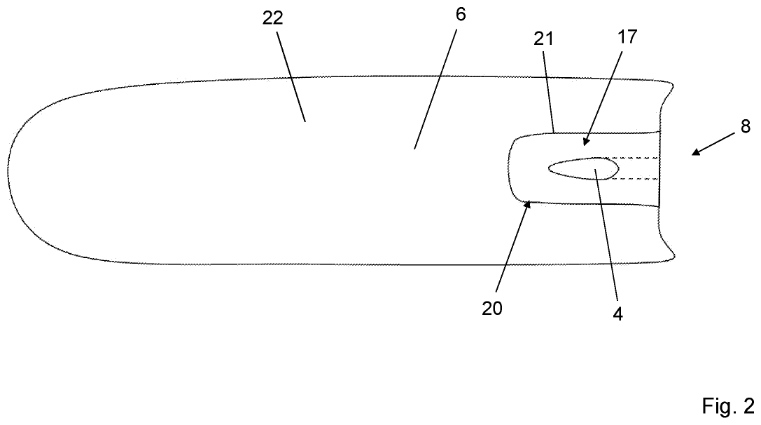

FIG. 2 shows a view from below of the surfboard in FIG. 1,

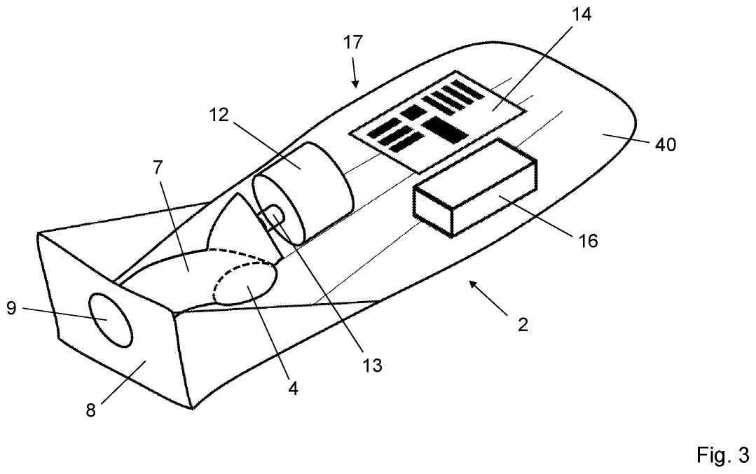

FIG. 3 shows a perspective view of a carrier according to the invention with components,

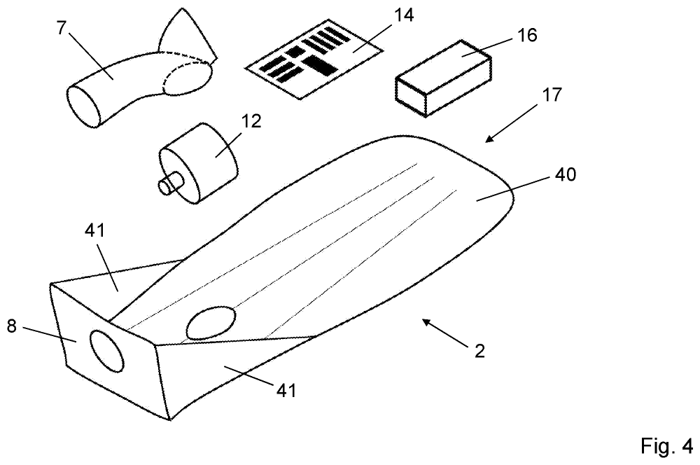

FIG. 4 shows an exploded view of the carrier with components removed.

In principle, a surfboard is to be understood as a device on which the surfer 1 stands, kneels or sits and which floats on water and advantageously has sufficient buoyancy to support the surfer. The buoyancy together with the forward propulsion provided to the surfboard 1 by a jet drive 2 should at least be sufficient so that the surfboard 1 moves over the water.

The surfboard 1 usually has no sail. In order that the surfer on the surfboard 1 can keep his balance more easily, in a variant of an embodiment a cord can extend from the bow end of the surfboard 1 and is advantageously provided with a handle which the surfer can additionally hold onto.

The surfboard 1 has the jet drive at the stern 3. The jet drive 2 comprises an opening towards the water inlet 4 in an underwater surface 6 of the surfboard 1 and a jet tube 7 with a water outlet 9 arranged on an end face 8 of the stern 3. The water outlet 9 is usually designed as a nozzle which, where appropriate, is pivotably rotatable about an axis of rotation arranged vertically with respect to a deck 11. In the jet tube 7 a rotor (not shown) is arranged, by which the water sucked into the jet tube 7 is sprayed out of the nozzle, thereby providing propulsion for the surfer with the surfboard 1. A motor 12 is arranged along a drive train 13 behind the rotor in the surfboard 1. The motor 12 drives the rotor. A controller 14 for the motor 12 is provided, by which the output of the motor 12 can be controlled; in particular the speed of the surfboard 1 can be controlled thereby. The controller 14 may be controllable for example by means of a wireless remote control which the surfer holds in his hand. Both the motor 12 and also the controller 14 are supplied with power by means of a battery (not shown). A converter 16 converts the direct current provided by the battery into alternating current. For this purpose the motor 12 is designed as an electric motor.

The surfboard 1 according to the invention has a carrier 17 on which are provided the jet tube 7, the motor 12 with the drive train 13 and the propeller which is arranged rotatably in the jet tube 7, as well as the controller 14 and the converter 16. A controller 14 is generally understood here as the electronic system on a main board which inter alia regulates the output of the motor 12, but for example also possibly acts upon the position of the nozzle with control signals.

The carrier 17 with the components of the jet drive 2 is set into a recess 20 at the stern end of the surfboard 1. The surfboard 1 is designed here with a permanently firm hull 22 made from a plastic coating and having a foam core. The plastic coating can be a laminate coating over the entire surface. The surfboard 1 has the recess 20 on an underwater surface 6 into which the carrier 17 fits in a positively locking manner, so that a planar surface forms over the entire underwater surface 6 which forms no groove or only a hardly perceptible, approximately U-shaped peripheral groove 21 between the hull 11 and the base panel 40 of the jet carrier 17.

The deck 11 is formed completely and continuously over an upper face of the board. The recess 20 is formed merely on the underwater surface 6 and on the end face 8 of the stern 3 of the surfboard 1.

FIG. 2 shows the surfboard 1 in a view from below, which shows the U-shaped recess 20 in the hull 22 of the surfboard 1, into which the carrier 17 with the water inlet 4 is inserted. The underwater surface 6 has a planar configuration after the introduction of the carrier 17 with the base panel 40. Likewise, the end face 8 of the stern 3 of the surfboard 1 has a planar configuration.

FIG. 3 shows the carrier 17 with the base panel 40 and the front face 8 of the stern, wherein the base panel 40 includes the opening for the water inlet 4 and the end face 8 of the stern 3 includes the opening for the water outlet 9. The same reference numerals designate the same components as in FIG. 1. The jet tube 7 is dimensioned so that it fits precisely between the water inlet 4 and the water outlet 9 and forms a water-conveying connection between the water inlet 4 and the water outlet 9.

In the jet tube 7 a rotor (not illustrated here) is provided which draws in the water entering the jet tube 7 and accelerates it and sprays it out rearwards, in order to provide the surfboard 1 with propulsion. The rotor is connected to the motor 12 by means of a drive train 13 which in turn is supplied with power via a battery (not shown). The controller 14 which is arranged on a main board is illustrated schematically.

The components are encapsulated individually in a watertight manner, in so far as this is necessary for them to function; in particular the motor 12 as well as the converter 16 and the controller 14 are encapsulated in a watertight manner.

The substrate 17 can be removed from the recess 20 after opening of fastening means such as clamping screws or the like. During removal at least the jet tube 7, the motor 12, the converter 16 and the controller 14 remain on the base panel 40 of the carrier 17 and are removed with it. If required, the individual components can be repaired or replaced, or the entire carrier 17 including all components can be replaced by a new carrier 17 including new components. The connectors for the battery are disconnected when the carrier 17 is removed, and the battery is not connected to the carrier 17.

FIG. 4 shows the jet drive 2 in a schematic dismantled view. The carrier 17 has the base panel 40 as well as the end face 8 of the stern 3. The end face 8 of the stern 3 is arranged on a stern edge of the base panel 40 and is connected to the base panel 40 for example by means of side walls or reinforcing brackets 41.

### LIST OF REFERENCE NUMERALS

1 surfboard
2 jet drive
3 stern
4 water inlet
6 underwater surface
7 jet tube
8 end face
9 water outlet
11 deck
12 motor
13 drive train
14 controller
16 converter
17 carrier
20 recess
21 groove
22 hull
40 base panel
41 reinforcing bracket

1. A Surfboard comprising: a hull (22) and a jet drive (2) arranged in the hull (22), characterised in that
the jet drive (2) is mounted on a carrier (17) and the carrier (17) can be releasably fastened to the hull (22) by fastening means and can be removed from the hull (22) together with the jet drive (2) after the release of the fastening means, and after the removal of the carrier (17) from the hull (22) the jet drive (2) is arranged freely accessibly on the carrier (17).

2. Surfboard according to claim 1,
characterised in that the carrier (17) has a base panel on which the jet drive (2) is mounted.

3. Surfboard according to claim 1,
characterised in that a battery for the jet drive (2) is arranged in the hull (22) and the battery is arranged separately from the carrier (17) in the surfboard (1) and is not removable together with the carrier (17).

4. Surfboard according to claim 1,
characterised in that the hull (22) has a recess (20) on the underside of the hull, and the carrier is inserted into the recess (20) and forms a planar surface with an outer skin of the surfboard (1).

5. Surfboard according to claim 1,
characterised in that a jet tube (7), a rotor, a motor (12), a controller (14) and a converter (16) are mounted on the carrier (17).

6. Surfboard according to claim 1,
characterised in that the carrier (17) has a planar base panel (40) with an opening for a water inlet (4) and an end face (8) projecting from the edge of the base panel at the stern end with an opening for a water outlet (9).

7. Surfboard according to claim 1,
characterised in that an inlet of the jet tube (7) is connected to the water inlet (4) and an outlet of the jet tube (7) is connected to the water outlet (9).

8. Surfboard according to claim 1,
characterised in that the carrier (17) with components mounted thereon is set into the recess (20) in the hull (22) of the surfboard (1), and an underside of the carrier (17) forms a planar surface with an underwater surface (6) of the hull (22).

9. Surfboard according to claim 1,
characterised in that the hull (22) has an inflatable hull component.

10. Surfboard according to claim 1,
characterised in that the carrier (17) with components mounted thereon is part of a drive unit which can be inserted into the recess (20) at the stern end of a hull component.
